(19) United States
(12) Patent Application Publication
(10) Pub. No.: US 2026/0181716 A1
(43) Pub. Date: Jun. 25, 2026

(54) WIRELESS MULTI-UPLINK SELECTION FOR MLO MESH NETWORK

(71) Applicant: Hewlett Packard Enterprise Development LP, Spring, TX (US)

(72) Inventors: Xiong Zhang, Shanghai (CN); Xiaoyang Fu, Beijing (CN); Haitao Yu, Beijing (CN); Jing Ma, Beijing (CN)

(21) Appl. No.: 18/989,091

(22) Filed: Dec. 20, 2024

(51) Int. Cl. H04W 76/15; H04W 84/18

(52) U.S. Cl. CPC H04W 76/15; H04W 84/18

(57) ABSTRACT

A method for optimizing a topology of a mesh network. The method comprises determining a topology of a mesh network and a first access point (AP) to be added to the mesh network. The method further comprises determining a multi-uplink group between the first AP and the second AP. The method further comprises determining a first number of sibling APs of the first AP and a second number of neighbor APs of the first AP by determining the second AP as a parent AP of the first AP. The method further comprises determining a metric value for the multi-uplink group based on the first number of sibling APs and the second number of neighbor APs of the first AP. The method further comprises adding, based on determining that the metric value meets a predetermined condition, the first AP into the mesh network according to the multi-uplink group.

### BACKGROUND

Mesh portal point (MPP) and mesh access point (MAP) are key components in a mesh network. The MPP acts as a gateway between the mesh network and external networks, such as the Internet or a wired local area network (LAN). The MPP may be a root node in the mesh network that directly connects to the external network via Ethernet or another wired connection. The MAP is a node within the mesh network that facilitates wireless communication by extending the coverage of the network and routing data packets. MAPs connect wirelessly to other MAPs and the MPP to form a self-organizing network.

Multi-link operation (MLO) is a feature introduced in Wi-Fi 7. MLO allows a non-AP multi-link device (MLD) to discover, authenticate, associate, and establish multiple links with an AP MLD. Once the MLD setup procedure is complete, each link facilitates channel access and frame exchanges between the non-AP MLD and the AP MLD.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example implementations of the present disclosure may be implemented;

FIG. 2 shows a schematic diagram illustrating an example of multiple uplinks between two APs according to the implementations of the present disclosure;

FIG. 3 shows a schematic diagram illustrating an example of a competition and interference model for a mesh network according to the implementations of the present disclosure;

FIG. 4 shows a schematic diagram illustrating an example of impacts of enabling a new radio of an AP on siblings and neighbors of the AP according to the implementations of the present disclosure;

FIG. 5 shows a schematic diagram illustrating an example of two stages for determining the uplinks of the APs according to the implementations of the present disclosure;

FIG. 6 shows a flow chart illustrating an example process of the initial stage for determining the uplinks of the APs according to the implementations of the present disclosure;

FIG. 7 shows a schematic diagram illustrating an example of the initial stage for determining the uplinks of the APs according to the implementations of the present disclosure;

FIG. 8 shows a flow chart illustrating an example process of the online optimization stage for determining the uplinks of the APs according to the implementations of the present disclosure;

FIG. 9 shows a schematic diagram illustrating an example of the online optimization stage for determining the uplinks of the APs according to the implementations of the present disclosure;

FIG. 10 shows a flow chart illustrating an example process of optimizing a topology of a mesh network according to the implementations of the present disclosure;

FIG. 11 shows a flow chart illustrating another example process of optimizing a topology of a mesh network according to the implementations of the present disclosure;

FIG. 12 shows a diagram illustrating an example electric device according to the implementations of the present disclosure; and

FIG. 13 shows a diagram illustrating an example AP according to the implementations of the present disclosure.

### DETAILED DESCRIPTION

In mesh networks, the selection and adjustment of wireless mesh links for each MAP are critical aspects. A well-optimized topology is essential for maximizing network capacity and ensuring overall efficiency. With the introduction of the latest Wi-Fi 7 standard, MLO functionality has significantly enhanced the throughput and capacity of MAPs. However, existing metrics and algorithms for mesh networks still focus on single-link cases, making them suitable only for legacy Wi-Fi standards. The multi-uplink scenario in the Wi-Fi 7 standard has not yet been addressed.

For example, a typical AP MLD has multiple links established on different radios, each with corresponding parameters such as received signal strength indicator (RSSI), transmit power, channel utilization, traffic, and load. Traditional algorithms evaluate each uplink individually and select a single link from multiple links on multiple radios. However, a mesh AP MLD can simultaneously maintain multiple uplinks, containing a subset of all possible links (e.g., 5 GHz+6 GHz or 2.4 GHz+5 GHz+6 GHz, etc.). Furthermore, using all links between two APs to transmit data may only slightly improve the transmission rate, but it can have a significant negative impact on sibling and neighbor APs. Therefore, enabling all links between two APs can only obtain a locally optimal solution rather than a globally optimal solution.

The scheme of the present disclosure considers the MLO features and the impact of increasing uplinks on other APs. Specifically, a network management system (NMS) may establish a topology of a mesh network by using a top-down incremental algorithm. Assuming some APs of the mesh network have been added into a topology of the mesh network, the NMS may obtain a first AP (e.g., the first AP may have three links including 2.4 GHz, 5 GHz, and 6 GHz) from the APs have not been added into the topology, and obtain a second AP (e.g., the second AP may also have three links including 2.4 GHz, 5 GHz, and 6 GHz) from existing APs in the topology. The NMS may determine a candidate multi-uplink group (e.g., 2.4 GHz and 5 GHz) between the first AP and the second AP. That means data can be transmitted between the first AP and the second AP through the links in the multi-uplink group. Then, the NMS may determine a number of sibling APs and a number of neighbor APs of the first AP in the topology by treating the second AP as a parent AP of the first AP. Then, the NMS may determine a metric value for the candidate multi-uplink group based on the number of sibling APs and the number of neighbor APs of the first AP, where the metric value may indicate a capacity of the candidate multi-uplink group. If the metric value meets a predetermined condition, the NMS may add the first AP into the topology according to the candidate multi-uplink group.

In this way, the mesh network can transmit data through multiple uplinks between APs, thereby improving the performance of the mesh network. Furthermore, in the established mesh network, the competition between the sibling APs and the interference between the neighbor APs can be reduced. Thus, the performance of the mesh network can be further improved.

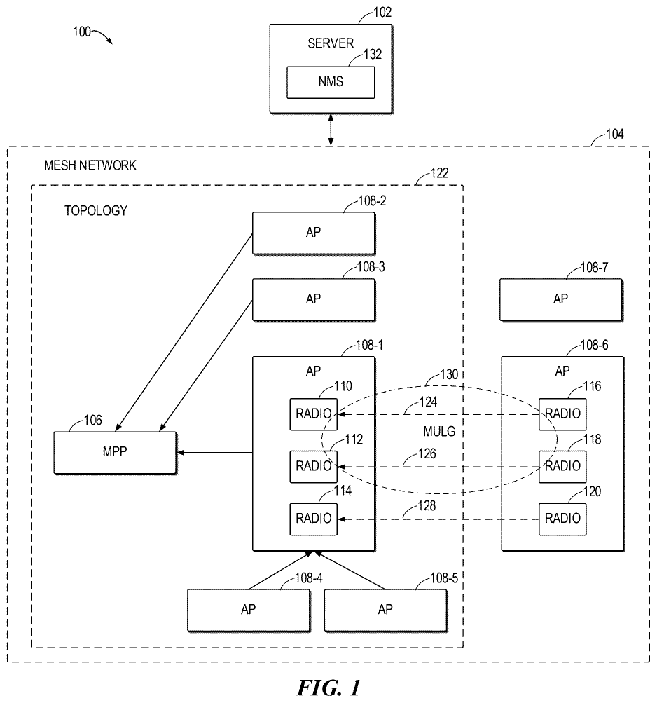

FIG. 1 illustrates an example environment 100 in which example implementations of the present disclosure may be implemented. As shown in FIG. 1, the environment 100 includes a server 102 and a mesh network 104. The mesh network 104 includes an MPP 106, and APs 108-1, 108-2, 108-3, 108-4, 108-5, 108-6, and 108-7 (also collectively referred to as APs 108). The MPP 106 connects the mesh network 104 to external wired or wireless networks, enabling devices within the mesh network 104 to communicate with the internet or other external resources. The APs 108 may expand the reach of the wireless network by routing traffic between client devices and the MPP 106 or other APs in the mesh network 104.

In the environment 100, the MPP 106 and the APs 108 are AP MLDs. An AP MLD supports multiple simultaneous links (e.g., 2.4 GHz, 5 GHz, and 6 GHz) to communicate with client devices or other APs. This allows the aggregation of bandwidth and resources across multiple channels, providing higher throughput and better performance. A multi-uplink group (MULG) refers to an aggregation of multiple wireless uplink connections between APs that utilize multiple frequency bands or radios. The MULG may enable an AP to maintain multiple active uplinks to another AP or an MPP. These uplinks may work together to transmit and receive data, providing higher aggregated throughput and reliability.

In the environment 100, the MPP 106 and the APs 108 may communicate with a network management system (NMS) 132 deployed on the server 102. The MPP 106 and the APs 108 may scan on their radios to get information associated with these APs (e.g., capabilities of the radios and information of neighbor APs). Then, the MPP 106 and the APs 108 may report their scan results to the NMS 132. Therefore, the NMS 132 obtains information of all these APs with a global perspective.

In the environment 100, the NMS 132 may re-establish a topology of the mesh network 104 to optimize the performance of the mesh network 104 after obtaining information of the MPP 106 and the APs 108. The NMS 132 may establish a new topology of the mesh network 104 by using a top-down incremental algorithm. For example, as shown in FIG. 1, the NMS 132 has established a topology 122. In the topology 122, the MPP 106 is a root node of a tree structure. The APs 108-1, 108-2, and 108-3 are connected to the MPP 106. Therefore, the MPP 106 is a parent AP of the APs 108-1, 108-2, and 108-3, and the APs 108-1, 108-2, and 108-3 are child APs of the MPP 106. Traffic may be transmitted through uplinks from the APs 108-1, 108-2, and 108-3 to the MPP 106. In addition, the APs 108-4 and 108-5 are connected to the AP 108-1. Therefore, the AP 108-1 is a parent AP of the APs 108-4 and 108-5, and the APs 108-4 and 108-5 are child APs of the AP 108-1. Traffic may be transmitted through uplinks from the APs 108-4 and 108-5 to the AP 108-1.

The next step is adding one of the APs 108-6 and 108-7 into the topology 122 to form a new topology. In the environment 100, the AP 108-1 may include a radio 110 (e.g., 2.4 GHz), a radio 112 (e.g., 5 GHz), and a radio 114 (e.g., 6 GHz). The AP 108-6 may include a radio 116 (e.g., 2.4 GHz), a radio 118 (e.g., 5 GHz), and a radio 120 (e.g., 6 GHz). When the NMS 132 determines the AP 108-1 as a parent AP of the AP 108-6, there may be several candidate MULGs between the AP 108-1 and the AP 108-6. The candidate MULGs may include an MULG including an uplink 124 from the radio 116 to the radio 110, an MULG including an uplink 126 from the radio 118 to the radio 112, an MULG including an uplink 128 from the radio 120 to the radio 114, an MULG including the uplinks 124 and 126, an MULG including the uplinks 124 and 128, an MULG including the uplinks 126 and 128, and an MULG including the uplinks 124, 126, and 128. In addition, when the NMS 132 determines the AP 108-1 as a parent AP of the AP 108-7, there may be other candidate MULGs between the AP 108-1 and the AP 108-7.

In the environment 100, the NMS 132 may select a candidate MULG, for example, an MULG 130 including the uplinks 124 and 126. Then, the NMS 132 may determine siblings APs of the AP 108-6 in the topology 122, and determine neighbor APs of the AP 108-6 in the topology 122. In FIG. 1, the APs 108-4, 108-5, and 108-6 have a same parent AP (i.e., the AP 108-1). Therefore, the siblings APs of the AP 108-6 in the topology 122 may include the APs 108-4 and 108-5. Furthermore, the neighbor APs of the AP 108-6 in the topology 122 may include the APs 108-2 and 108-3.

In the environment 100, the NMS 132 may determine a metric value for the MULG 130 based on the number of the sibling APs of the AP 108-6 and the number of the neighbor APs of the AP 108-6. The metric value for an MULG may indicate a capacity of the MULG. The capacity of the MULG refers to the combined ability of all the links within the group to transmit data. For example, the capacity of the MULG may be a data rate of the MULG.

After obtaining the metric value for the MULG 130, the NMS 132 may determine whether the metric value meets a predetermined condition. In some implementations, the NMS 132 may generate a new topology by adding the AP 108-6 into the topology 122 according to the MULG 130, and determine a comprehensive metric value for the new topology based on the metric value for the MULG 130. The comprehensive metric value for the new topology may indicate an overall capacity of the new topology. In some implementations, the predetermined condition may be that the comprehensive metric value for the new topology is the largest value of a plurality of comprehensive metric values determined for all candidate MULGs. In some implementations, the predetermined condition may be that the comprehensive metric value for the new topology meets a predetermined threshold value.

If the NMS 132 determines that the metric value for the MULG 130 meets the predetermined condition, the NMS 132 may add the AP 108-6 into the topology 122, and enable the uplinks 124 and 126 according to the MULG 130. If the metric value for the MULG 130 does not meet the predetermined condition, the NMS 132 may add the AP 108-6 or the AP 108-7 according to another MULG.

In this way, the mesh network 104 can transmit data through multiple uplinks between APs, thereby improving the performance of the mesh network 104. Furthermore, in the established mesh network 104, the competition between the sibling APs and the interference between the neighbor APs can be reduced. Thus, the performance of the mesh network 104 can be further improved.

In some implementations, the NMS may calculate the metric values for the MULGs based on a metric determination algorithm. This algorithm takes into account both the parameters of the radios of the AP and the competition and interference between the multiple mesh nodes. A link reduction coefficient may be introduced to quantify the reduction effects caused by the interference and the competition. Then, a comprehensive metric value for an AP may be defined to represent an actual capacity of the AP within the overall network topology. With this metric determination algorithm, the accuracy of the capacity of the mesh node in the MLD mesh network can be improved. This enhanced evaluation can provide valuable insights for optimizing the entire mesh network, thereby improving its overall performance and efficiency.

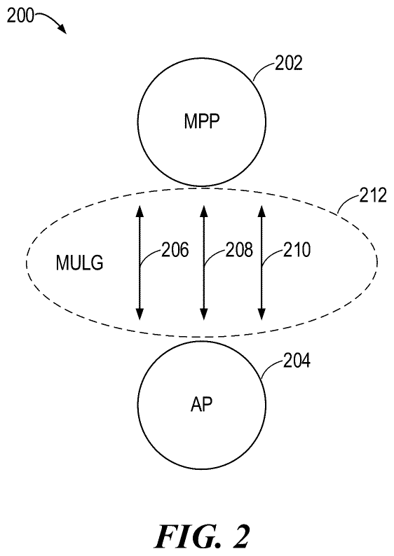

FIG. 2 shows a schematic diagram illustrating an example 200 of multiple uplinks between two APs according to the implementations of the present disclosure. As shown in FIG. 2, the example 200 includes an MPP 202 and an AP 204, where the MPP 202 and theAP 204 are MLDs. The MPP 202 and the AP 204 may have multiple radios working on multiple radio frequency bands. According to the Wi-Fi 7 standards, an MLD mesh point can simultaneously establish uplinks on all its available radios, thereby forming an MULG. As shown in FIG. 2, the MPP 202 and the AP 204 may have three different radios on corresponding bands (e.g., 2.4 GHz, 5 GHz, and 6 GHz). At most three links, for example links 206, 208, and 210, may be established on these radios. For example, a 3-link MULG 212 between the MPP 202 and the AP 204 may be formed.

A capacity C_{Σ} of an MULG may be determined by calculating a sum of per-link capacities Cᵢ of single links Lᵢ on the radios, where the link Lᵢ belongs to the MULG and i denotes an index of the link. The capacity C_{Σ} of the MULG may be calculated by Equation (1) as below:

$${C}_{Σ} = {\sum }_{{L}_{i} ∈ M U L G} {C}_{i} \qquad ( 1 )$$

For example, in FIG. 2, a capacity of the link 206, a capacity of the link 208, and a capacity of the link 210 may be determined. Then, a capacity of the MULG 212 may be determined by calculating a sum of the capacity of the link 206, the capacity of the link 208, and the capacity of the link 210.

Ideally, in the absence of interference, the capacity Cᵢ of the link Lᵢ can achieve a theoretical maximum data rate. The theoretical maximum data rate may be determined based on the RF parameters of the radio and a negotiated highest modulation and coding scheme (MCS) index. The negotiated highest MCS index may be determined based on a bandwidth, a number of spatial streams (NSS), and the capabilities of the link Lᵢ. The actual capacity Cᵢ of the link Lᵢ may be estimated by Equation (2) as below:

$${C}_{i} = {f}_{i} \cdot {R}_{i} where {R}_{i} = γ ( bandwidth , nss , capabilities ) \qquad ( 2 )$$

Where Rᵢ denotes the theoretical maximum data rate of the link Lᵢ with a given bandwidth, a given NSS, and given capabilities of the link Lᵢ. Furthermore, a function γ denotes a function configured to determine the theoretical maximum data rate based on a bandwidth, an NSS, and capabilities. In addition, a link reduction coefficient fᵢ denotes a reduction of capacity of the link Lᵢ caused by the competition and the interference.

For example, in FIG. 2, theoretical maximum data rates corresponding to the links 206, 208, and 210 may be determined based on bandwidths, NSSs, and capabilities of these links. Furthermore, link reduction coefficients corresponding to the links 206, 208, and 210 may be determined. Then, the capacities of the links 206, 208, and 210 may be calculated based on the theoretical maximum data rates and the link reduction coefficients of these links.

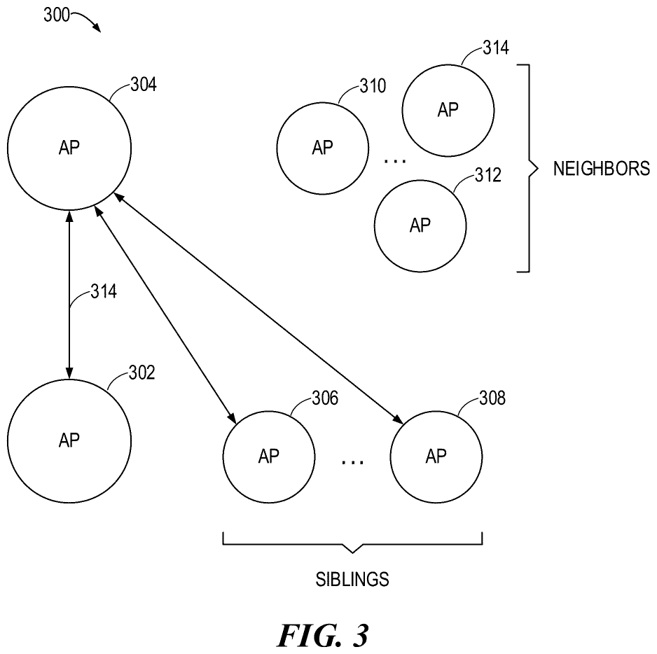

When considering competition and interference, the actual link capacity decreases accordingly. For a mesh node, its sibling nodes may share the upstream capacity of the parent node. Additionally, neighbor nodes may introduce channel interference, thereby further reducing the actual data rates. FIG. 3 shows a schematic diagram illustrating an example 300 of a competition and interference model for a mesh network according to the implementations of the present disclosure.

As shown in FIG. 3, the example 300 includes an AP 302. The AP 302 may be connected to a parent AP 304 through a link 314. Furthermore, in the example 300, APs 306 and 308 are also connected to the parent AP 304, and they are siblings of the AP 302 on a radio corresponding to the link 314. In addition, in the example 300, APs 310, 312, and 314 are neighbors of the AP 302 on the radio corresponding to the link 314.

As described above, the link reduction coefficient fᵢ may denote the reduction of the capacity of the link Lᵢ caused by the competition and the interference. This link reduction coefficient may indicate a proportion of media resources an AP can obtain relative to its siblings and neighbors. In some implementations, a competition reduction coefficient Pᵢ may be determined based on a number of the siblings of the AP. The competition reduction coefficient Pᵢ may indicate a reduction of the actual capacity of the link Lᵢ caused by the competition between the AP and its siblings. In some implementations, an interference reduction coefficient Tᵢ may be determined based on the number of the neighbors of the AP. The interference reduction coefficient Tᵢ may indicate a reduction of the actual capacity of the link Lᵢ caused by the interference between the AP and its neighbors. Therefore, the link reduction coefficient fᵢ may be determined based on the competition reduction coefficient Pᵢ and the interference reduction coefficient Tᵢ. For example, the link reduction coefficient fᵢ may be calculated by Equation (3) as below:

$${f}_{i} = \frac{1}{1 + {αN}_{S}} \cdot \frac{1 + {N}_{S}}{1 + {N}_{S} + β {N}_{R}} = {φ}_{i} ( {N}_{S} , {N}_{R} ) , 0 < α , β < 1 \qquad ( 3 )$$

Where N_{S} denotes the number of siblings of the AP on the same radio corresponding to the link Lᵢ, N_{R} denotes the number of neighbors of the AP on the same radio beside the siblings of the AP, α and β are weighting factors that respectively represent impact of the siblings and the neighbors on this radio, and φᵢ(N_{S}, N_{R}) denotes a function mapping the number of siblings and the number of neighbors to the link reduction coefficient fᵢ. Furthermore, in Equation (3),

$$\frac{1}{1 + {αN}_{S}}$$

may indicate the competition reduction coefficient Pᵢ, and

$$\frac{1 + {N}_{S}}{1 + {N}_{S} + β {N}_{R}}$$

may indicate the interference reduction coefficient Tᵢ.

Then, the actual capacity Cᵢ of the single link Lᵢ may be rewritten as Equation (4) as below:

$${C}_{i} = {φ}_{i} ( {N}_{S} , {N}_{R} ) {R}_{i} \qquad ( 4 )$$

For an AP with multiple uplinks, the actual capacity of its MULG may be rewritten as Equation (5) as below:

$${C}_{Σ} = {\sum }_{{L}_{i} ∈ M U L G} {φ}_{i} ( {N}_{S} , {N}_{R} ) {R}_{i} \qquad ( 5 )$$

Taking into account the loss and reduction effects along a multi-hop path, an end-to-end metric value for the AP may be determined based on a hop count from the MPP (i.e., the root node) to the AP and a per-hop reduction factor. The end-to-end metric value for the AP may indicate a capacity that the AP can ultimately achieve from the MPP through its multi-hop connection. For example, the end-to-end metric value M_{AP} for the AP may be calculated by Equation (6) as below:

$${M}_{A P} = {λ}^{h} {C}_{Σ} = {λ}^{h} {\sum }_{{L}_{i} ∈ MULG} {φ}_{i} ( {N}_{S} , {N}_{R} ) {R}_{i} \qquad ( 6 )$$

Where λ (0<λ<1) denotes the per-hop reduction factor, and h denotes the hop count from the MPP to the AP.

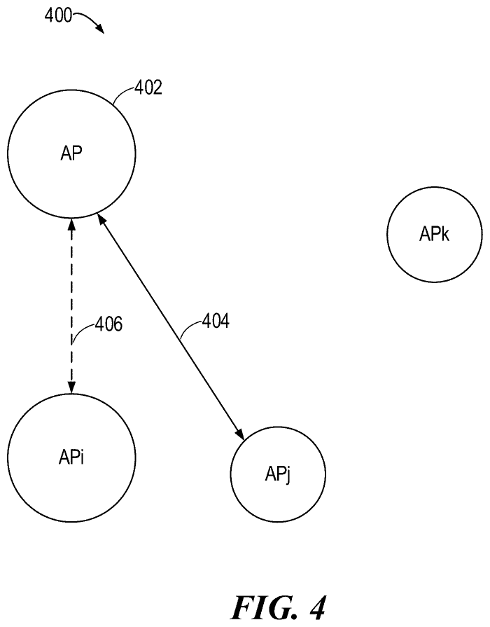

For an individual AP, adding more radios to its MULG may increase its overall metric value, as the total capacity is the aggregated sum of the capacities of each individual link. However, enabling an additional uplink on a radio of one AP may impact the link reduction coefficients of other APs utilizing the same radio. FIG. 4 shows a schematic diagram illustrating an example 400 of the impacts of enabling a new radio of an AP on siblings and neighbors of the AP according to the implementations of the present disclosure.

As shown in FIG. 4, an AP 402 is a parent of an APⱼ. The APⱼ may be connected to the AP 402 through a link 404 on a radio (e.g., 2.4 GHz). Furthermore, an APₖ may be a neighbor of the APⱼ on the same radio with the link 404. In the example 400, if a new link 406 from an AP; to the AP 402 on the same radio is enabled, both the number of siblings N_{S}_{ⱼ} of the APⱼ and the number of neighbors N_{R}_{ₖ} of the APₖ may be increased, leading to a decrease in the link reduction coefficients fⱼ and fₖ for both the APⱼ and the APₖ. The link reduction coefficients fⱼ and fₖ may be represented by Equation (7) as below:

$${f}_{j} = {φ}_{j} ( {N}_{{S}_{j}}^{′} , {N}_{{R}_{j}} ) , {N}_{{S}_{j}}^{′} = {N}_{{S}_{j}} + 1 \qquad ( 7 )$$

$${f}_{k} = {φ}_{k} ( {N}_{{S}_{k}} , {N}_{{R}_{k}}^{′} ) , {N}_{{R}_{k}}^{′} = {N}_{{R}_{k}} + 1$$

Where N_{R}_{ⱼ} denotes the number of neighbors of the APⱼ, and N_{S}_{ₖ} denotes the number of siblings of the APₖ.

Therefore, increasing a metric value for one AP by enabling additional radios may lead to a decrease in a metric value for another AP due to the introduction of the competition and the interference.

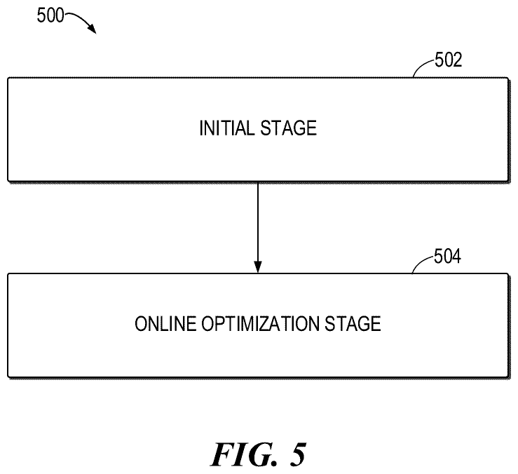

FIG. 5 shows a schematic diagram illustrating an example 500 of two stages for determining the uplinks of the APs according to the implementations of the present disclosure. As shown in FIG. 5, the example 500 includes an initial stage 502 and an online optimization stage. In the initial stage 502, APs are not connected to an NMS (e.g., the NMS 134 in FIG. 1) when they are bootstrapped. Therefore, each AP may select a locally optimal MULG from the perspective of an individual AP. In some implementations, in the initial stage 502, the AP may use a constrained greedy algorithm to select uplinks to a parent AP from available uplinks. The constrained greedy algorithm may utilize a ratio threshold associated with the capacities of the uplinks to constrain whether to enable an uplink of the AP. Then, the mesh network may be established based on the uplinks selected by the APs. In this way, the uplinks with less benefit may not be enabled, thereby the competition and the interference on the corresponding bands can be reduced, and the overall performance of the mesh network can be improved.

After the mesh network being established, in the online optimization stage 504, the APs may communicate with the NMS. Therefore, the NMS may obtain information of the APs in the mesh network. Then, the NMS may optimize the topology of the mesh network from the global perspective based on the information of the APs. In the online optimization stage 504, the NMS may establish an optimized topology of the mesh network using a top-down incremental algorithm. Therefore, when the NMS adds a new AP into a current topology, the NMS may determine a number of the siblings of the AP and a number of neighbors of the AP, and determine whether to add this AP into the topology and which uplinks are enabled based on the information of the APs, the number of the siblings, and the number of the neighbors. In this way, a globally optimized topology of the mesh network can be determined, thereby the performance of the mesh network can be improved.

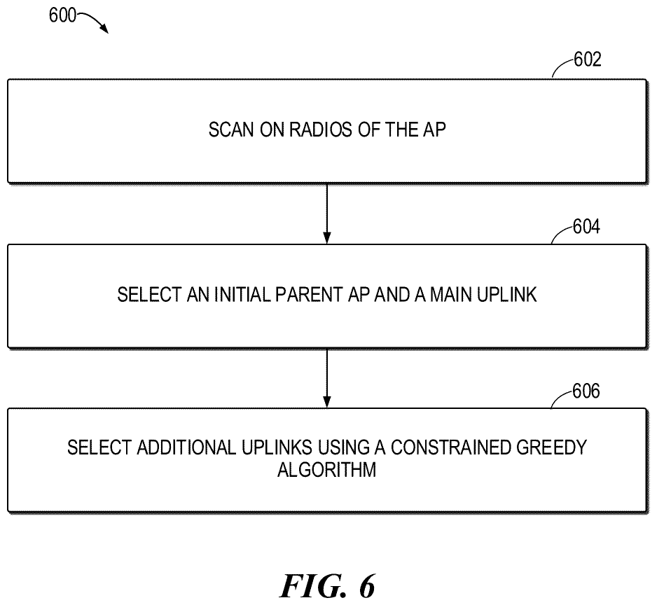

FIG. 6 shows a flow chart illustrating an example process 600 of the initial stage for determining the uplinks of the APs according to the implementations of the present disclosure. The process 600 may be implemented by an AP. As shown in FIG. 6, at block 602, the AP may scan its radios to obtain the capabilities of the radios, siblings on these radios, and neighbors on these radios. Furthermore, during the initial stage, the AP is not yet connected to any parent AP. Therefore, the AP may obtain a list of candidate parent APs in the mesh network.

At block 604, the AP may select an initial parent AP and a main uplink radio. Based on the scan results, the AP may evaluate metric values for single uplinks with each candidate parent on all its radios individually. For example, if the AP has three radios and two candidate parent AP, six metric values for six single uplinks may be evaluated. Then, the AP may determine the single uplink with the largest metric value as the main uplink, and determine the parent AP corresponding to the main uplink as the initial parent of the AP. The metric value M′_{i,n} for the main uplink L_{i,n} may be represented by Equation (8) as below:

$${M}_{i , n}^{′} = {λ}^{{h}_{n} + 1} {C}_{i , n} \qquad ( 8 )$$

Where C_{i,n} denotes a capacity of the main uplink L_{i,n}, i denotes an index of the radio of the main uplink L_{i,n}, n denotes an index of the initial parent AP, and hₙ denotes a hop count of the initial parent AP.

At block 606, the AP may select additional uplinks using the constrained greedy algorithm. As described above, adding more uplinks to an MULG may increase the metric value for an AP but may decrease the metric value for another AP because of the competition and the interference. Considering the benefits of adding uplinks and the reduction influence on other APs, the constrained greedy algorithm may be used to add additional uplinks into the MULG including the main uplink during the initial stage.

After the initial parent AP and the main uplink L_{i,n} are determined, the AP may evaluate the capacity C_{j,n} of the remaining link L_{j,n}, where j≠i. The AP may determine whether the capacity C_{j,n} of the link L_{j,n} and the capacity C_{i,n} of the main uplink L_{i,n} meets a predetermined condition. If the AP determines that the capacity C_{j,n} and the capacity C_{i,n} meet the predetermined condition, the AP may enable the link L_{j,n} in the topology of the mesh network by adding the link L_{j,n} into the MULG including the main uplink L_{i,n}. In some implementations, the AP may determine a ratio of the capacity C_{j,n} to the capacity C_{i,n} of the main uplink L_{i,n}. If the ratio is greater than a predetermined ratio threshold ΔC, the AP may determine that the capacity C_{j,n} and the capacity C_{i,n} meet the predetermined condition. The condition may be represented by Equation (9) as below:

$${C}_{j , n} \geq Δ C \cdot {C}_{i , n} \qquad ( 9 )$$

In this way, in the mesh network, the additional uplinks with acceptable quality can be enabled, and the unreasonable uplinks can be filtered out. The constrained greedy algorithm can prevent unlimited use of a specific channel, which could lead to overcrowding and degrade the performance of other APs operating on the same channel. Thus, the performance of the mesh network can be improved.

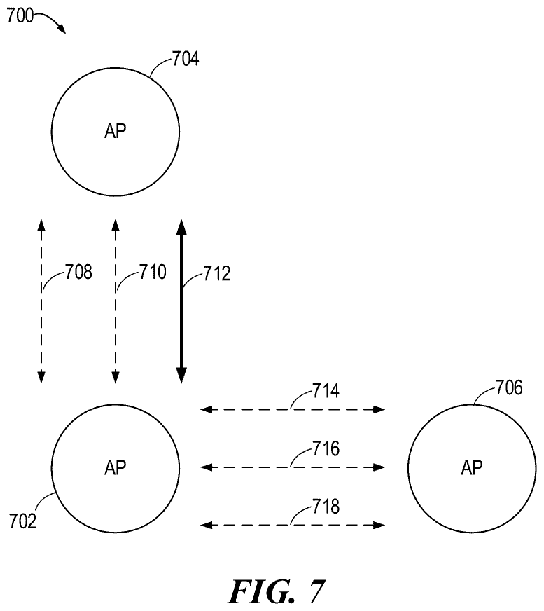

FIG. 7 shows a schematic diagram illustrating an example 700 of the initial stage for determining the uplinks of the APs according to the implementations of the present disclosure. As shown in FIG. 7, the example 700 includes APs 702, 704, and 706, where each AP has three radios. The AP 702 needs to determine uplinks to be enabled in the initial stage. The AP 702 may determine that the APs 704 and 706 are candidate parent APs. Then, the AP 702 may scan each radio to obtain the capabilities of the radio, sibling APs on the radio, and neighbor APs on the radio.

As shown in FIG. 7, in the example 700, there are three uplinks 708, 710, and 712 from the AP 702 to the candidate parent AP 704, and three uplinks 714, 716, and 718 from the AP 702 to the candidate parent AP 706. The AP 702 may calculate six capacities of the six uplinks based on the capabilities, the number of siblings, and the number of neighbors. For example, the capacity of the uplink 712 may be the largest of the six capacities. Therefore, the AP 702 may select the uplink 712 as the main uplink according to Equation (8).

Because the uplink 712 is selected as the main uplink, the AP 704 may be determined as the initial parent AP. Then, the AP 702 may determine whether to enable additional uplinks between the AP 702 and the AP 704. The AP 704 may compare the capacity of the uplink 708 to the capacity of the uplink 712. If the capacity of the uplink 708 and the capacity of the uplink 712 satisfy Equation (9), the AP 702 may enable the uplink 708 in the initial stage. In addition, the AP 702 may also compare the capacity of the uplink 710 to the capacity of the uplink 712. If the capacity of the uplink 710 and the capacity of the uplink 712 satisfy Equation (9), the AP 702 may also enable the uplink 710 in the initial stage.

In this way, in the mesh network established in the initial stage, the main uplink with a largest capacity can be enabled. Furthermore, the additional uplinks with high capacity can be enabled also, and the uplinks with low capacity can be filtered out. Thus, the competition and the interference among the APs can be reduced, and the performance of the mesh network can be improved.

After the initial stage is completed, the uplinks for each AP are just bootstrapped to reach an initial status with a good capacity, meanwhile also avoiding too much competition and interference to other nodes. However, for the overall network, the per-AP greedy strategy in the initial stage cannot ensure a globally optimized topology, as an AP does not account for the capacity of other nodes. For each AP, after establishing uplinks and connecting to its parent during the initial stage, it will also connect to the NMS and report its scan results. The NMS may then gather information from all APs, providing a global view of the network.

In the online optimization stage, a total sum of metric values for all APs in a topology may be calculated, as an overall metric value for the topology. The overall metric value may indicate a total capacity of the topology. The overall metric value M_{Σ} for a topology may be calculated by Equation (10) as below:

$${M}_{Σ} = {\sum }_{k = 1}^{n} {M}_{A {P}_{k}} \text{==} {\sum }_{k = 1}^{n} {λ}^{{h}_{k}} {\sum }_{{L}_{i} ∈ M U L {G}_{k}} {φ}_{i} ( {N}_{S} , {N}_{R} ) {R}_{i} \qquad ( 10 )$$

Where APₖ denotes an AP with an index k, hₖ denotes the hop count from the MPP to the APₖ, M_{AP}_{ₖ} denotes a capacity of the APₖ, and MULGₖ denotes the multi-uplink group for the APₖ.

It should be noted that, in Equation (10), the MPP directly connecting to the backbone network with Ethernet may be omitted, because its capacity is fixed and only related to an Ethernet uplink.

According to Equation (10), finding the largest value of the overall metric value M_{Σ} is a complex optimization problem with a vast solution space, as each AP may connect to potential parent nodes with various combinations of MULGs.

The NMS may utilize an intuitive top-down incremental algorithm to search for improved metric values. For example, a topology Tₙ may include n nodes. The NMS may determine how to add a candidate APₙ₊₁ into this topology by selecting the optimal parent and uplinks to form a larger topology Tₙ₊₁. By using this incremental strategy, the topology of the entire network can be constructed step-by-step. In this top-down approach, the APs with fewer hops may have higher priorities for acquiring optimized capacities compared to leaf nodes. This aligns with the tree-structured nature of a mesh network, where APs with fewer hops require higher capacities to efficiently convey downstream data.

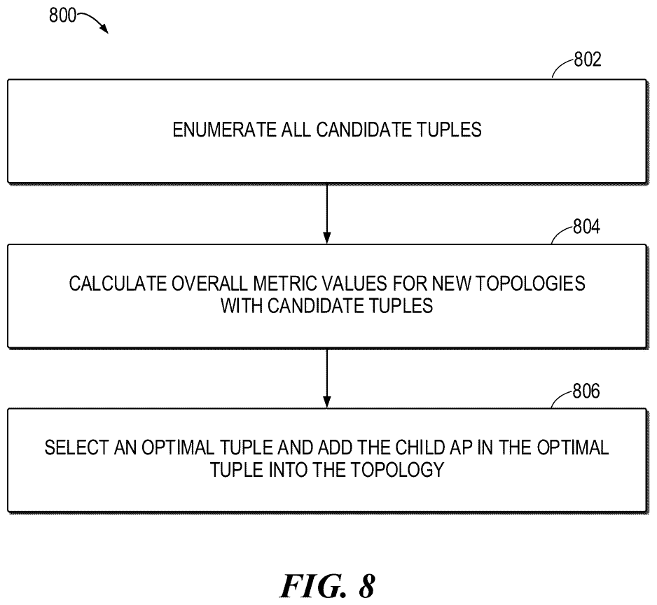

FIG. 8 shows a flow chart illustrating an example process 800 of the online optimization stage for determining the uplinks of the APs according to the implementations of the present disclosure. The example process 800 may implemented by an NMS. In the process 800, for a current topology, the NMS may select a tuple consisting of a parent AP, a child AP, and an MULG between the parent AP and the child AP. The parent AP is a part of the current topology, while the child AP is outside of the current topology. Compared to other potential tuples, the selected tuple can maximize the metric value for the extended topology with n+1 nodes.

At block 802, the NMS may enumerate all candidate tuples. For each AP belonging to a current topology, consider every possible child AP that is outside the current topology. The NMS may determine all potential MULGs between the two APs, encompassing all possible combinations of their available radios.

At block 804, the NMS may calculate overall metric values for new topologies with candidate tuples. For a candidate tuple, the NMS may construct a new topology containing n+1 nodes, where the child AP may be connected to the parent AP through the MULG in the candidate tuple. The overall metric value for the new topology may be calculated by Equation (10).

At block 806, the NMS may select an optimal tuple and add the child AP in the optimal tuple into the topology. By calculating the overall metric value for each candidate tuple, the NMS may select the tuple with the largest overall metric value as the optimal tuple. By repeating the process 800, all APs can be added into the topology one by one, thereby constructing an optimized topology of the mesh network.

In this way, the NMS can manage the entire mesh network with a global perspective. By using the top-down incremental algorithm, optimal uplinks can be identified, thereby enhancing the overall network performance.

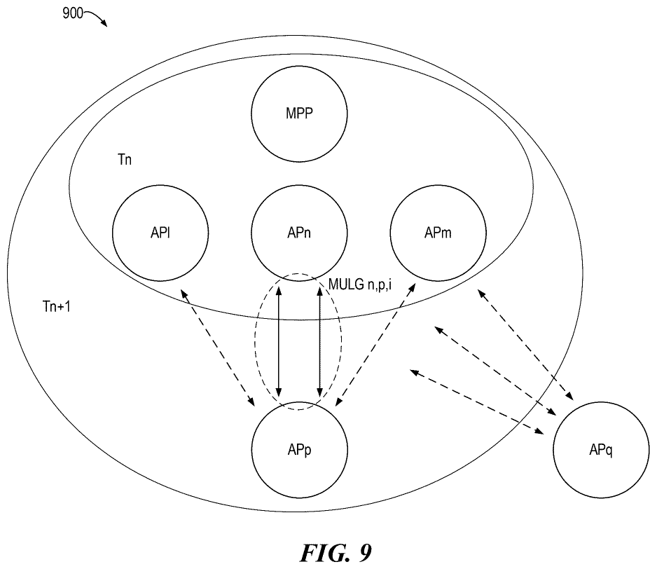

FIG. 9 shows a schematic diagram illustrating an example 900 of the online optimization stage for determining the uplinks of the APs according to the implementations of the present disclosure. As shown in FIG. 9, the example 900 includes an MPP, an APₘ, an APₗ, an APₙ, an APₚ, and an AP_{q}. The NMS may determine a current topology Tₙ of the mesh network, where the topology Tₙ already includes the MPP, the APₘ, the APₗ, and the APₙ. The NMS may evaluate all possible child APs for them, such as the APₚ and the AP_{q}. Subsequently, the NMS may determine all potential MULGs, including an MULG_{n,p,i}, where the MULG_{n,p,i} denotes an MULG between the parent APₙ and the child APₚ, and i denotes an index of a specific combination of multiple uplinks.

In the example 900, the NMS may determine a tuple (APₙ, APₚ, MULG_{n,p,i}), then construct a new topology containing n+1 nodes based on the tuple (APₙ, APₚ, MULG_{n,p,i}), where the child APₚ may be connected to the parent APₙ through the MULG_{n,p,i}. The overall metric value for the new topology Tₙ₊₁ including the n+1 nodes may be calculated by Equation (10). Other nodes are excluded and ignored, including the calculation of the numbers of siblings and the number of neighbors of the n+1 nodes.

In the example 900, the tuple (APₙ, APₚ, MULG_{n,p,i}) may have the largest overall metric value. Then, the APₙ may be added to the current topology Tₙ, and the AP_{q} fails to be added to the topology Tₙ. Therefore, a larger topology Tₙ₊₁ can be constructed.

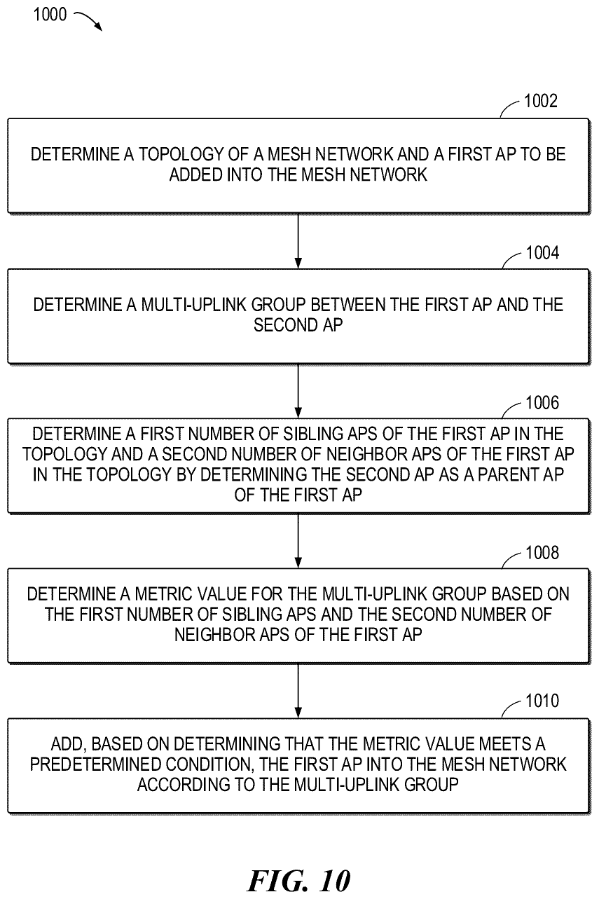

FIG. 10 shows a flow chart illustrating an example process 1000 of optimizing a topology of a mesh network according to the implementations of the present disclosure. The process 1000 may be implemented by an electric device (e.g., a server) or an NMS deployed on the electric device. As shown in FIG. 10, at block 1002, the NMS may determine a topology of a mesh network and a first AP to be added into the mesh network, the topology comprising a second AP, the first AP and the second AP being multi-link devices. At block 1004, the NMS may determine a multi-uplink group between the first AP and the second AP, the multi-uplink group comprising one or more uplinks from the first AP to the second AP. At block 1006, the NMS may determine a first number of sibling APs of the first AP in the topology and a second number of neighbor APs of the first AP in the topology by determining the second AP as a parent AP of the first AP. At block 1008, the NMS may determine a metric value for the multi-uplink group based on the first number of sibling APs and the second number of neighbor APs of the first AP, the metric value indicating a capacity of the multi-uplink group. At block 1010, the NMS may add, based on determining that the metric value meets a predetermined condition, the first AP into the mesh network according to the multi-uplink group.

In this way, the mesh network can transmit data through multiple uplinks between APs, thereby improving the performance of the mesh network. Furthermore, in the established mesh network, the competition between the sibling APs and the interference between the neighbor APs can be reduced. Thus, the performance of the mesh network can be further improved.

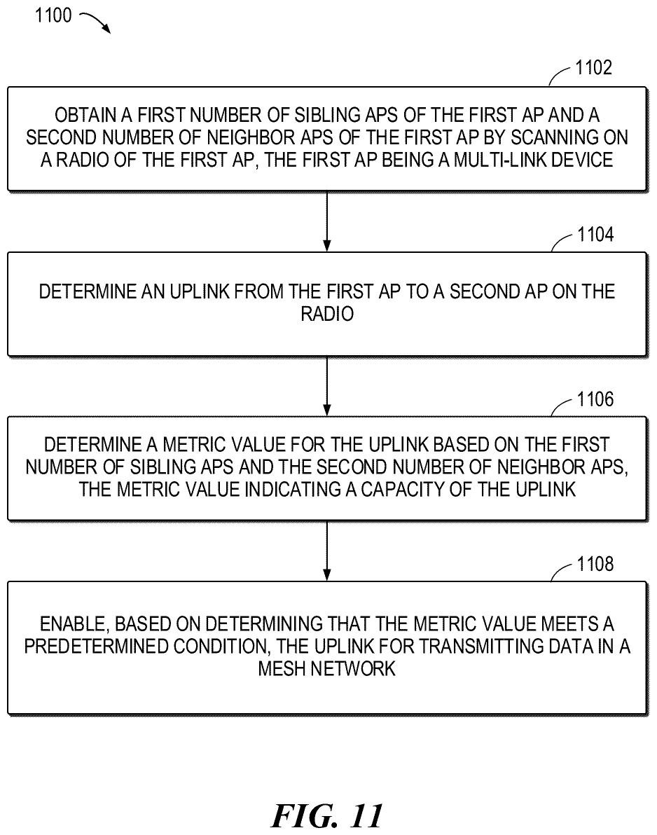

FIG. 11 shows a flow chart illustrating another example process 1100 of optimizing a topology of a mesh network according to the implementations of the present disclosure. The process 1100 may be implemented by an AP. As shown in FIG. 11, at block 1102, a first AP may obtain a first number of sibling APs of the first AP and a second number of neighbor APs of the first AP by scanning on a radio of the first AP, the first AP being a multi-link device. At block 1104, the first AP may determine an uplink from the first AP to a second AP on the radio. At block 1106, the first AP may determine a metric value for the uplink based on the first number of sibling APs and the second number of neighbor APs, the metric value indicating a capacity of the uplink. At block 1108, the first AP may enable, based on determining that the metric value meets a predetermined condition, the uplink for transmitting data in a mesh network.

In this way, the mesh network can transmit data through multiple uplinks between APs, thereby improving the performance of the mesh network. Furthermore, the competition and the interference among the APs can be reduced, and the performance of the mesh network can be improved.

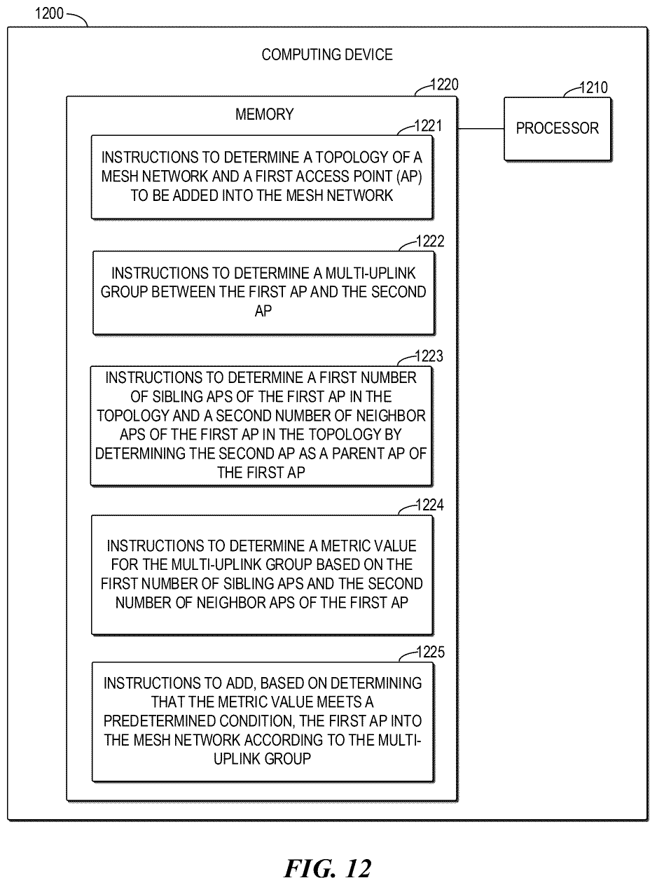

FIG. 12 shows a diagram illustrating an example electric device 1200 according to the implementations of the present disclosure. As shown in FIG. 12, the electric device 1200 comprises at least one processor 1210, and a memory 1220 coupled to the at least one processor 1210. The memory 1220 stores instructions 1221, 1222, 1223, and 1224 to cause the processor 1210 to perform actions according to example implementations of the present disclosure.

As shown in FIG. 12, the memory 1220 stores the instructions 1221 to determine a topology of a mesh network and a first AP to be added into the mesh network, the topology comprising a second AP, the first AP and the second AP being multi-link devices. The memory 1220 further stores the instructions 1222 to determine a multi-uplink group between the first AP and the second AP, the multi-uplink group comprising one or more uplinks from the first AP to the second AP. The memory 1220 further stores the instructions 1223 to determine a first number of sibling APs of the first AP in the topology and a second number of neighbor APs of the first AP in the topology by determining the second AP as a parent AP of the first AP. The memory 1220 further stores the instructions 1224 to determine a metric value for the multi-uplink group based on the first number of sibling APs and the second number of neighbor APs of the first AP, the metric value indicating a capacity of the multi-uplink group. The memory 1220 further stores the instructions 1225 to add, based on determining that the metric value meets a predetermined condition, the first AP into the mesh network according to the multi-uplink group.

The stored instructions and the functions that the instructions may perform can be understood with reference to implementations as described above. For brevity, the details of instructions 1221, 1222, 1223, 1224, and 1225 will not be discussed herein.

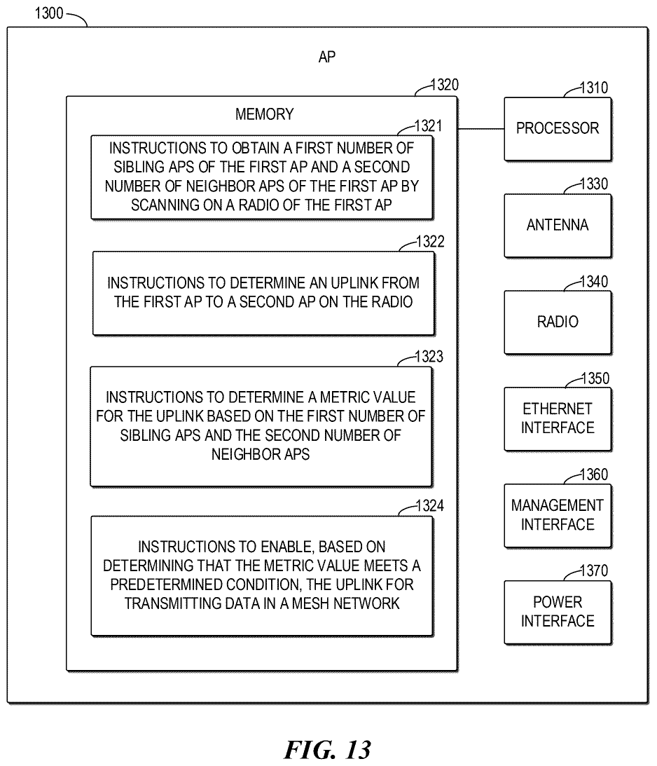

FIG. 13 shows a diagram illustrating an example AP 1300 according to the implementations of the present disclosure. As shown in FIG. 13, the AP 1300 comprises at least one processor 1310, a memory 1320 coupled to the at least one processor 1310, at least one antenna 1330, at least one radio 1340, an Ethernet interface 1350, a management interface 1360 and a power interface 1370. The memory 1320 stores instructions 1321, 1322, 1323, and 1324 to cause the processor 1310 to perform actions according to example implementations of the present disclosure.

As shown in FIG. 13, the memory 1320 stores the instructions 1321 to obtain a first number of sibling APs of the first AP and a second number of neighbor APs of the first AP by scanning on a radio of the first AP, the first AP being a multi-link device. The memory 1320 further stores the instructions 1322 to determine an uplink from the first AP to a second AP on the radio. The memory 1320 further stores the instructions 1323 to determine a metric value for the uplink based on the first number of sibling APs and the second number of neighbor APs, the metric value indicating a capacity of the uplink. The memory 1320 further stores the instructions 1324 to enable, based on determining that the metric value meets a predetermined condition, the uplink for transmitting data in a mesh network.

The stored instructions and the functions that the instructions may perform can be understood with reference to implementations as described above. For brevity, the details of instructions 1321, 1322, 1323, and 1324 will not be discussed herein.

The at least one antenna 1330 in the AP 1300 is a crucial component that allows the AP 1300 to communicate with wireless devices such as laptops, smartphones, and tablets. The primary function of the at least one antenna 1330 may be to transmit and receive wireless signals, converting electrical signals into radio waves for outgoing communication and vice versa for incoming signals.

The at least one radio 1340 in the AP 1300 is responsible for wireless communication. The at least one radio 1340 may handle the conversion of data between wired and wireless forms, making it possible for the AP 1300 to transmit and receive data over the air. In a modulation process, the digital data from the wired network may be converted into radio waves for wireless transmission. In a demodulation process, incoming radio waves may be converted back into digital data that the AP 1300 can process. The at least one radio 1340 may operate on specific frequency bands, such as 2.4 GHz, 5 GHz, or 6 GHz bands. The at least one radio 1340 may ensure effective communication by selecting appropriate channels to minimize interference. The performance of the at least one radio 1340 may be defined by various Wi-Fi standards, including 802.11a/b/g/n/ac/ax, with newer standards like Wi-Fi 6 and Wi-Fi 7 offering improved speed, efficiency, and capacity.

The Ethernet interface 1350 in the AP 1300 may be used for connecting the AP 1300 to the local network, providing a bridge between the wired and wireless segments of the network. The AP 1300 may connect to routers, switches, or directly to the internet through the Ethernet interface 1350, enabling the wireless devices to communicate with other network resources and the broader internet. The Ethernet interface may support various speeds, including Fast Ethernet (e.g., 100 Mbps), Gigabit Ethernet (e.g., 1 Gbps), and even Multi-Gigabit Ethernet.

The management interface 1360 in the AP 1300 may allow network administrators to configure, monitor, and manage the settings and performance of the AP 1300. The management interface 1360 may be accessed through various methods, such as a web browser, command line interface (CLI), or network management protocols like Simple Network Management Protocol (SNMP). Through the management interface 1360, the administrators can set up and modify SSIDs, security protocols, VLANs, and other operational parameters, ensuring the AP 1300 operates effectively within the network environment.

The power interface 1370 in the AP 1300 may supply the necessary electrical power to the device, ensuring that the AP 1300 may operate smoothly and effectively. This can be achieved through a direct power supply using an AC adapter connected to a power outlet, or via Power over Ethernet (PoE), which delivers power through the same Ethernet cable used for data transmission.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
determining a topology of a mesh network and a first access point (AP) to be added into the mesh network, the topology comprising a second AP, the first AP and the second AP being multi-link devices;
determining a multi-uplink group between the first AP and the second AP, the multi-uplink group comprising one or more uplinks from the first AP to the second AP;
determining a first number of sibling APs of the first AP in the topology and a second number of neighbor APs of the first AP in the topology by determining the second AP as a parent AP of the first AP;
determining a metric value for the multi-uplink group based on the first number of sibling APs and the second number of neighbor APs of the first AP, the metric value indicating a capacity of the multi-uplink group; and
adding, based on determining that the metric value meets a predetermined condition, the first AP into the mesh network according to the multi-uplink group.

2. The method according to claim 1, wherein the topology is a first topology, and determining that the metric value meets the predetermined condition comprises:
generating a second topology by adding the first AP into the first topology according to the multi-uplink group;
determining a comprehensive metric value for the second topology based on the metric value for the multi-uplink group, the comprehensive metric value indicating an overall capacity of the second topology; and
determining that the metric value meets the predetermined condition by determining that the comprehensive metric value for the second topology meets the predetermined condition.

3. The method according to claim 2, wherein the multi-uplink group is a first multi-uplink group, the comprehensive metric value is a first comprehensive metric value, and determining that the comprehensive metric value for the second topology meets the predetermined condition comprises:
generating a plurality of candidate topologies based on a plurality of candidate multi-uplink groups, the plurality of candidate multi-uplink groups comprising the first multi-uplink group, and the plurality of candidate topologies comprising the second topology;
determining a plurality of comprehensive metric values for the plurality of candidate topologies, the plurality of comprehensive metric values comprising the first comprehensive metric value; and
determining that the first comprehensive metric value for the second topology meets the predetermined condition by determining that the first comprehensive metric value is a largest value of the plurality of comprehensive metric values.

4. The method according to claim 1, wherein the multi-link group comprises a first uplink, and determining the metric value for the multi-uplink group based on the first number of sibling APs and the second number of neighbor APs of the first AP comprises:
determining a maximum data rate of the first uplink;
determining a reduction coefficient based on the first number of sibling APs and the second number of neighbor APs of the first AP;
determining an actual capacity of the first uplink based on the maximum data rate and the reduction coefficient; and
determining the metric value for the multi-uplink group based on the actual capacity of the first uplink.

5. The method according to claim 4, wherein determining the reduction coefficient based on the first number of the sibling APs and the second number of the neighbor APs of the first AP comprises:
determining a first coefficient based on the first number of the sibling APs of the first AP, the first coefficient indicating a first reduction of the actual capacity of the first uplink caused by competition between the first AP and the sibling APs of the first AP;
determining a second coefficient based on the second number of the neighbor APs of the first AP, the second coefficient indicating a second reduction of the actual capacity of the first uplink caused by interference between the first AP and the neighbor APs of the first AP; and
determining the reduction coefficient based on the first coefficient and the second coefficient.

6. The method according to claim 4, wherein the actual capacity of the first uplink is a first actual capacity, the multi-link group further comprises a second uplink, and determining the metric value for the multi-uplink group based on the actual capacity of the first uplink comprises:
determining a second actual capacity of the second uplink;
determining a total actual capacity for the multi-link group based on the first actual capacity and the second actual capacity; and
determining the metric value of the multi-uplink group based on the total actual capacity.

7. The method according to claim 6, wherein determining the metric value of the multi-uplink group based on the total actual capacity comprises:
determining a hop count from the first AP to a root AP of the mesh network;
obtaining a per-hop reduction factor; and
determining the metric value of the multi-uplink group based on the total actual capacity, the hop count, and the per-hop reduction factor.

8. The method according to claim 4, wherein determining the maximum data rate of the first uplink comprises:
obtaining a bandwidth, a number of spatial streams, and a capability of the first uplink; and
determining the maximum data rate of the first uplink based on the bandwidth, the number of spatial streams, and the capability of the first uplink.

9. A method comprising:
obtaining, by a first access point (AP), a first number of sibling APs of the first AP and a second number of neighbor APs of the first AP by scanning on a radio of the first AP, the first AP being a multi-link device;
determining, by the first AP, an uplink from the first AP to a second AP on the radio;
determining, by the first AP, a metric value for the uplink based on the first number of sibling APs and the second number of neighbor APs, the metric value indicating a capacity of the uplink; and
enabling, by the first AP and based on determining that the metric value meets a predetermined condition, the uplink for transmitting data in a mesh network.

10. The method according to claim 9, wherein the uplink is a first uplink, the metric value is a first metric value, and determining that the metric value meets the predetermined condition comprises:
determining a plurality of candidate uplinks associated with a plurality of candidate parent APs of the first AP, the plurality of candidate uplinks comprising the first uplink;
determining a plurality of metric values for the plurality of candidate uplinks; and
determining that the first metric value meets the predetermined condition by determining that the first metric value is a largest value in the plurality of metric values.

11. The method according to claim 9, wherein the uplink is a first uplink, the metric value for the first uplink is a first metric value, the predetermined condition is a first predetermined condition, and the method further comprises:
determining a second uplink from the first AP to the second AP after enabling the first uplink;
determining a second metric value for the second uplink; and
determining that the first metric value and the second metric value meet a second predetermined condition; and
enabling the second uplink for transmitting data in the mesh network.

12. The method according to claim 11, wherein determining that the first metric value and the second metric value meet the predetermined condition comprises:
determining a ratio of the second metric value to the first metric value; and
determining that the first metric value and the second metric value meet the predetermined condition by determining that the ratio is greater than a predetermined ratio threshold.

13. The method according to claim 9, wherein determining the metric value for the uplink based on the first number of sibling APs and the second number of neighbor APs comprises:
determining a maximum data rate of the uplink;
determining a reduction coefficient based on the first number of sibling APs and the second number of neighbor APs of the first AP;
determining an actual capacity of the uplink based on the maximum data rate and the reduction coefficient; and
determining the metric value for the uplink based on the actual capacity of the first uplink.

14. The method according to claim 13, wherein determining the reduction coefficient based on the first number of the sibling APs and the second number of the neighbor APs of the first AP comprises:
determining a first coefficient based on the first number of the sibling APs of the first AP, the first coefficient indicating a first reduction of the actual capacity of the uplink caused by competition between the first AP and the sibling APs of the first AP;
determining a second coefficient based on the second number of the neighbor APs of the first AP, the second coefficient indicating a second reduction of the actual capacity of the uplink caused by interference between the first AP and the neighbor APs of the first AP; and
determining the reduction coefficient based on the first coefficient and the second coefficient.

15. The method according to claim 13, wherein determining the metric value for the uplink based on the actual capacity of the first uplink comprises:
determining a hop count from the first AP to a root AP of the mesh network;
obtaining a per-hop reduction factor; and
determining the metric value of the uplink based on the actual capacity, the hop count, and the per-hop reduction factor.

16. An electric device comprising:
at least one processor; and
a memory coupled to the at least one processor, the memory storing instructions to cause the at least one processor to:
determine a topology of a mesh network and a first access point (AP) to be added into the mesh network, the topology comprising a second AP, the first AP and the second AP being multi-link devices;
determine a multi-uplink group between the first AP and the second AP, the multi-uplink group comprising one or more uplinks from the first AP to the second AP;
determine a first number of sibling APs of the first AP in the topology and a second number of neighbor APs of the first AP in the topology by determining the second AP as a parent AP of the first AP;
determine a metric value for the multi-uplink group based on the first number of sibling APs and the second number of neighbor APs of the first AP, the metric value indicating a capacity of the multi-uplink group; and
add, based on determining that the metric value meets a predetermined condition, the first AP into the mesh network according to the multi-uplink group.

17. The electric device according to claim 16, wherein the topology is a first topology, and the instructions causing the at least one processor to determine that the metric value meets the predetermined condition further cause the at least one processor to:
generate a second topology by adding the first AP into the first topology according to the multi-uplink group;
determine a comprehensive metric value for the second topology based on the metric value for the multi-uplink group, the comprehensive metric value indicating an overall capacity of the second topology; and
determine that the metric value meets the predetermined condition by determining that the comprehensive metric value for the second topology meets the predetermined condition.

18. The electric device according to claim 17, wherein the multi-uplink group is a first multi-uplink group, the comprehensive metric value is a first comprehensive metric value, and the instructions causing the at least one processor to determine that the comprehensive metric value for the second topology meets the predetermined condition further cause the at least one processor to:
generate a plurality of candidate topologies based on a plurality of candidate multi-uplink groups, the plurality of candidate multi-uplink groups comprising the first multi-uplink group, and the plurality of candidate topologies comprising the second topology;
determine a plurality of comprehensive metric values for the plurality of candidate topologies, the plurality of comprehensive metric values comprising the first comprehensive metric value; and
determine that the first comprehensive metric value for the second topology meets the predetermined condition by determining that the first comprehensive metric value is a largest value of the plurality of comprehensive metric values.

19. The electric device according to claim 16, wherein the multi-link group comprises a first uplink, and the instructions causing the at least one processor to determine the metric value for the multi-uplink group based on the first number of sibling APs and the second number of neighbor APs of the first AP further cause the at least one processor to:
determine a maximum data rate of the first uplink;
determine a reduction coefficient based on the first number of sibling APs and the second number of neighbor APs of the first AP;
determine an actual capacity of the first uplink based on the maximum data rate and the reduction coefficient; and
determine the metric value for the multi-uplink group based on the actual capacity of the first uplink.

20. The electric device according to claim 19, wherein the instructions causing the at least one processor to determine the reduction coefficient based on the first number of the sibling APs and the second number of the neighbor APs of the first AP further cause the at least one processor to:
determine a first coefficient based on the first number of the sibling APs of the first AP, the first coefficient indicating a first reduction of the actual capacity of the first uplink caused by competition between the first AP and the sibling APs of the first AP;
determine a second coefficient based on the second number of the neighbor APs of the first AP, the second coefficient indicating a second reduction of the actual capacity of the first uplink caused by interference between the first AP and the neighbor APs of the first AP; and
determine the reduction coefficient based on the first coefficient and the second coefficient.
